(19) United States
(12) Patent Application Publication
(10) Pub. No.: US 2026/0093370 A1
(43) Pub. Date: Apr. 2, 2026

(54) AUTOMATIC FLOATING WINDOW FOR VIRTUAL MEETINGS

(71) Applicant: Google LLC, Mountain View, CA (US)

(72) Inventors: Bo Wang, Santa Clara, CA (US); Denys Miasoutov, Aventura, FL (US); Lixia Liu, Redmond, CA (US); Nan Li, Kirkland, WA (US); Mai Truong Lowe, Durham (UT); Venkata Satyendra K. Ananthu, Bothell, WA (US); Sunbao Wu, Cary, NC (US)

(21) Appl. No.: 18/902,705

(22) Filed: Sep. 30, 2024

(51) Int. Cl. G06F 3/0481; H04L 12/18

(52) U.S. Cl. CPC G06F 3/0481; H04L 12/1813

(57) ABSTRACT

A method includes receiving, by a browser application, a first user interaction to initiate a virtual meeting in a first tab of the browser application. The method further includes receiving, during the virtual meeting, a second user interaction to switch a focus of the browser application to a second tab of the browser application. The method further includes, responsive to the focus of the browser application switching to the second tab of the browser application, causing a floating window to appear along with content of the second tab. The floating window includes one or more elements associated with the virtual meeting.

### TECHNICAL FIELD

Aspects and implementations of the present disclosure relate to virtual meetings, and in particular to automatically displaying virtual meeting elements in a floating window.

### BACKGROUND

Virtual meeting systems allow individuals to communicate using digital means. Some virtual meeting systems allow individuals to communicate without being in the same physical location. Some virtual meeting systems allow individuals to communicate within the same physical location (e.g., lecture hall, auditorium, etc.). Some virtual meeting systems allow communication using text, audio data, and/or video data. Some virtual meeting systems can provide closed-captions and/or transcription services that use speech recognition to convert spoken conversation into text.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a system and method are disclosed for automatically displaying virtual meeting elements in a floating window of a browser application. In an implementation, a method includes receiving, by a browser application, a first user interaction to join a virtual meeting in a first tab of the browser application. The method further includes receiving, during the virtual meeting, a second user interaction to switch a focus of the browser application to a second tab of the browser application. The method further includes, responsive to the focus of the browser application switching to the second tab of the browser application, causing a floating window to appear along with content of the second tab. The floating window can include one or more elements associated with the virtual meeting.

In some embodiments, the method further includes receiving a third user interaction to switch the focus of the browser application to the first tab of the browser application. The method further includes, responsive to the focus of the browser application switching to the first tab of the browser application, causing the floating window to disappear and causing the one or more elements associated with the virtual meeting to appear within the first tab of the browser application.

In some embodiments, the method further includes receiving a third user interaction to enlarge the floating window. The method further includes, responsive to the enlarging of the floating window, causing additional elements associated with the virtual meeting to appear within the floating window.

In some embodiments, the method further includes receiving a third user interaction to shrink the floating window. The method further includes, responsive to the shrinking of the floating window, causing a subset of the one or more elements associated with the virtual meeting to disappear from the floating window.

In some embodiments, the method further includes causing a sub-window to be displayed in the floating window. The method further includes receiving a third user interaction with the sub-window in the floating window. The method further includes, responsive to the third user interaction with the sub-window in the floating window, causing the focus of the browser application to switch to the first tab.

In some embodiments, the method further includes receiving a third user interaction with a first element of the one or more elements associated with the virtual meeting. The method further includes, responsive to receiving the third user interaction with the first element of the one or more elements associated with the virtual meeting, causing a meeting interaction to occur with the virtual meeting.

In some embodiments, the first tab of the browser application includes a web application that supports embedded virtual meetings.

In some embodiments a computer-readable storage medium (which may be a non-transitory computer-readable storage medium, although the invention is not limited to that) stores instructions which, when executed, cause a processing device to perform operations comprising a method according to any embodiment or aspect described herein.

In some embodiments a system comprises: a memory device; and a processing device operatively coupled with the memory to perform operations comprising a method according to any embodiment or aspect described herein.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system for automatically displaying virtual meeting elements in a floating window of a browser application, in accordance with at least one embodiment.

FIG. 2A depicts a view of a browser application window including a virtual meeting with automatic floating window support, in accordance with one embodiment.

FIG. 2B depicts a view of a browser application window with an automatic floating window containing virtual meeting elements within a virtual meeting user interface (UI), in accordance with one embodiment.

FIG. 3 depicts a flow diagram of an example method for automatically displaying virtual meeting elements in a floating window of a browser application, in accordance with at least one embodiment.

FIG. 4 is a block diagram illustrating an exemplary computer system, in accordance with at least one embodiment of the present disclosure.

### DETAILED DESCRIPTION

A virtual meeting client application can be displayed in a first tab or window of a browser application. The virtual meeting client application can present one or more virtual meeting participant representations, meeting controls, shared content, and/or the like. If a user of the browser application switches a focus of the browser application from the tab (or window) with the virtual meeting client application to another tab (or window) with another application (e.g., a note taking web application, a document drafting web application, etc.), the virtual meeting client application can be hidden, causing the user to stop interacting with the virtual meeting. The switching can result in consumption of additional computing resources because the user would need more time to complete a task associated with the other application (e.g., note taking, document drafting, etc.), and because the user would need to perform follow-up operations (e.g., emailing, texting, calling, and/or scheduling follow up meetings with other participants) to get up-to-speed on portions of the virtual meeting that were missed while the user was focused on the task associated with the other application. Additionally, a user may lose time, and therefore waste resources, when switching between tabs of the browser application if they cannot quickly find the tab that includes the virtual meeting.

Aspects of the present disclosure address the above and other deficiencies by automatically displaying virtual meeting elements in a floating window of a browser application along with content of another application. More specifically, when a user switches focus of a browser application from a tab with a virtual meeting client application to another tab, the browser application can automatically create a floating window that includes one or more virtual meeting elements to allow the user to continue interacting with the virtual meeting. The floating window can be displayed with (e.g., on top of, alongside of, etc.) content of another tab (or window) of the browser application.

For example, a first virtual meeting participant can join (or initiate) a virtual meeting using a virtual meeting client application within a first tab (or window) of a browser application of a client device of the first virtual meeting participant. During the virtual meeting, the first virtual meeting participant can switch a focus of the browser application to another tab (or window). For example, the first virtual meeting participant may switch the focus of the browser application to a note taking application, a document drafting application, a website, a chat application, etc. When the focus of the browser application switches from the tab with the virtual meeting client application to the second tab, a floating window of the browser application can be displayed with the content of the second tab. The floating window can include one or more virtual meeting elements, such as virtual meeting participant representations and/or meeting controls, to allow the first virtual meeting participant to continue interacting with the virtual meeting while interacting with the content of the second tab of the browser application.

In some embodiments, the floating window can be resized. For example, the floating window may initially have a first size and may display a first set of virtual meeting elements. If the first virtual meeting participant enlarges the size of the floating window, one or more additional virtual meeting elements can be displayed. For example, additional virtual meeting participant representations can be included in the enlarged floating window. If the first virtual meeting participant shrinks the size of the floating window, a subset of the virtual meeting elements can be displayed. For example, one or more virtual meeting participant representations can be hidden in the shrunken floating window.

The size of the floating window can be different for different virtual meeting participants. For example, a first virtual meeting participant may enlarge the floating window on their client device, and a second virtual meeting participant may shrink the floating window on their client device. The changes a first virtual meeting participant makes to the floating window on their client device may not change a floating window on another virtual meeting participant's client device.

In some embodiments, if the first virtual meeting participant switches the focus of the browser application back to the first tab (e.g., back to the virtual meeting client application tab), the floating window can automatically disappear and the one or more virtual meeting elements that were displayed in the floating window can be displayed in the first tab of the browser application.

In some embodiments, a sub-window can be displayed within the floating window. For example, the sub-window can include a message or notification to the user regarding the virtual meeting. Responsive to the first virtual meeting participant interacting with the sub-window, focus of the browser application can switch back to the virtual meeting client application tab and the floating window can automatically disappear.

In some embodiments, virtual meeting participants can participate in the same virtual meeting using different virtual meeting clients. For example, a first virtual meeting participant may join the virtual meeting using a virtual meeting client in a browser application. A second virtual meeting participant may join the virtual meeting using an application on a mobile device. A third virtual meeting participant may join the virtual meeting using a virtual meeting room. Virtual meeting participants using a virtual meeting client in a browser application may benefit from the automatic floating window discussed herein. In some embodiments, the virtual meeting experience may be similar whether a virtual meeting participant is interacting with the virtual meeting within a tab of the browser application or within the floating window of the browser application.

Advantages of the disclosed embodiments over the existing technology include but are not limited to reduced resource consumption as a user can participate in a virtual meeting and work on a task (e.g., document drafting, note taking, content presentation, etc.) simultaneously, resulting in less time (and therefore resources) required to complete the task and eliminating the need to use additional resources to follow up after the meeting to catch up on any meeting items that were missed. Additionally, when the virtual meeting is included in a floating window, the user does not need to spend additional time looking for the browser application tab with the virtual meeting after working on their task.

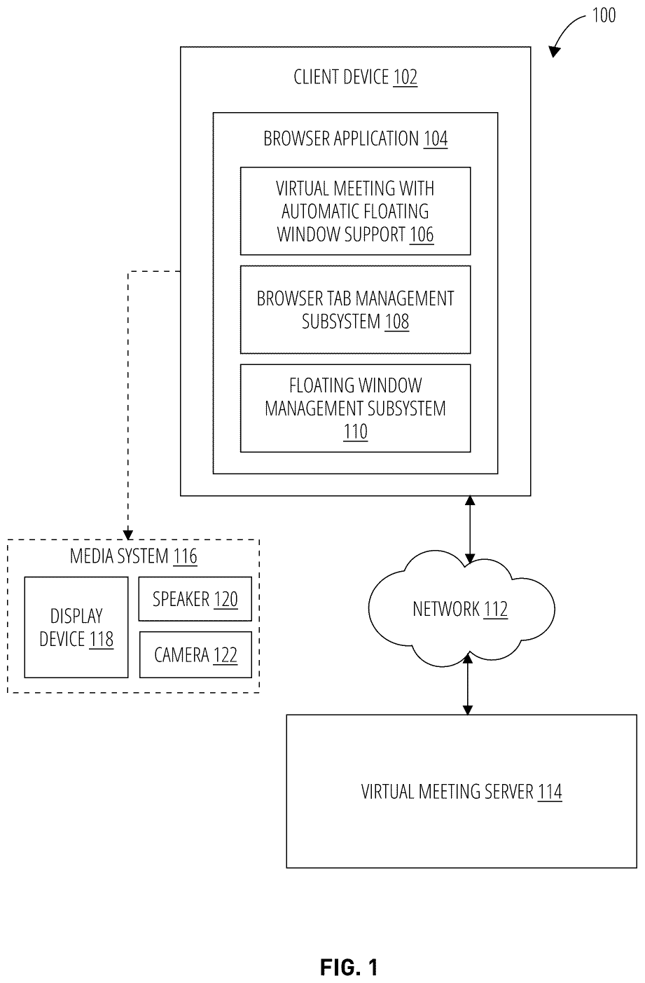

FIG. 1 illustrates an example system 100 for automatically displaying virtual meeting elements in a floating window of a browser application, in accordance with at least one embodiment. System 100 can include client device 102 and virtual meeting server 114 connected via network 112, such as a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

Client device 102 can correspond to a user and can enable the user to connect to and interface with virtual meeting server 114. The client device (e.g., virtual meeting participant device) can include an audiovisual component that can generate audio and video data to be streamed to virtual meeting server 114. The audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a virtual meeting participant device. In some implementations, the audiovisual component includes an image capture device (e.g., a camera) to capture images and generate video data (e.g., a video stream) of the captured images.

In some embodiments, at least one of the virtual meeting participant devices is associated with a physical conference or meeting room and can include or be coupled to media system 116 that can include one or more display devices 118, one or more speakers 120, and one or more cameras 122. Display device 118 can be, for example, a smart display or a non-smart display (e.g., a display that is not itself configured to connect to the network). Users that are physically present in the room can use media system 116 rather than their own devices (e.g., client device 102) to participate in the virtual meeting, which can include other remote users. For example, the users in the room that participate in the virtual meeting can control display device 118 to show a slide presentation or watch slide presentations of other participants. Sound and/or camera control can similarly be performed. The virtual meeting participant devices associated with a physical conference or meeting room can generate audio and video data to be streamed to virtual meeting server 114 (e.g., using one or more microphones, speakers, and/or cameras of the virtual meeting participant device).

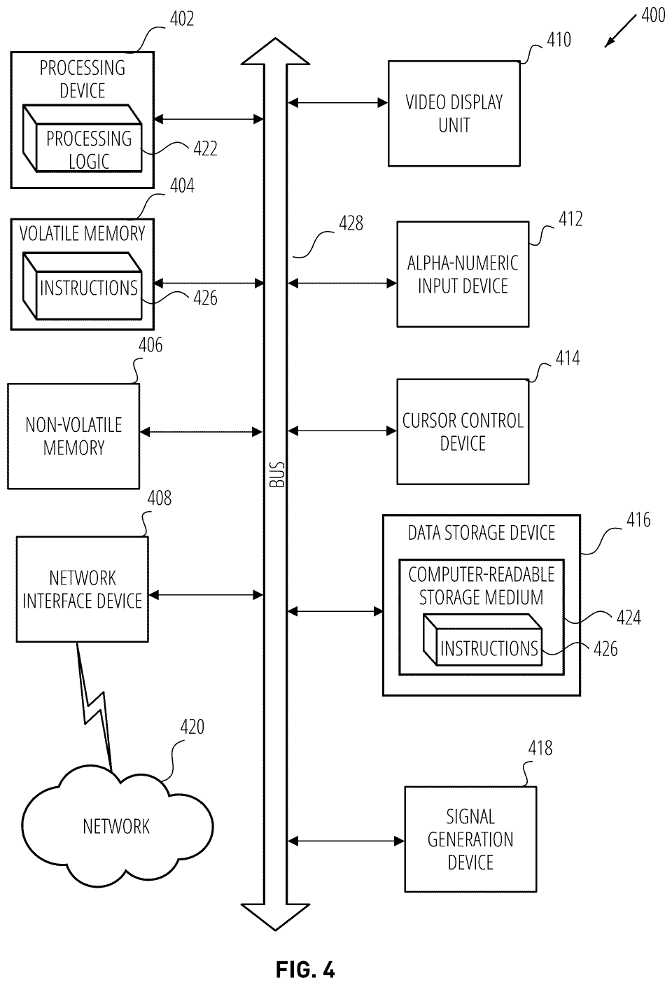

In some embodiments, client device 102 can include one or more processing devices, volatile and non-volatile memory, data storage, one or more input/output peripherals such as network interfaces. FIG. 4 illustrates an example architecture of computing devices. In some embodiments, client device 102 is a singular device such as a smartphone, tablet, laptop, desktop, workstation, edge device, embedded device, server, network appliance, security appliance, etc. In some embodiments, client device 102 comprises multiple devices of similar or varying architecture such as computing clusters, data centers, co-located servers, enterprise networks, geographically disparate devices connected via virtual private networks (VPNs), etc. In some embodiments, client device 102 comprises hardware devices such as those just described, virtual resources such as virtual machines (VMs) and containerized applications, or a combination of hardware and virtual resources.

Client device 102 can include a browser application (e.g., browser application 104) for connecting (e.g., via network 112) to applications (e.g., web sites, web applications (“web apps”), etc.). For example, browser application 104 can connect to a virtual meeting client application, such as virtual meeting with automatic floating window support 106. Virtual meeting with automatic floating window support 106 can include code that is executed by the browser application (e.g., browser application 104) and runs on the virtual meeting participants device (e.g., client device 102). In some embodiments, the code for virtual meeting with automatic floating window support 106 is provided (e.g., via network 112) by virtual meeting server 114.

Browser application 104 can include browser tab management subsystem 108 for managing browser application tabs and their associated content. For example, browser tab management subsystem 108 can track how many tabs are currently open within browser application 104, can track which tab is currently focused, and can present (e.g., display, render, etc.) the contents of the currently focused tab.

Browser application 104 can include floating window management subsystem 110 for managing the automatic floating windows of the browser application, as discussed herein. For example, when a user switches focus from a tab with a virtual meeting client application to another tab, floating window management subsystem 110 can automatically display a floating window that includes one or more elements associated with the virtual meeting. For example, one or more virtual meeting participant representations that were displayed in the tab with the virtual meeting client application can be displayed in the floating window. Meeting control elements can also be displayed in the floating window. Floating window management subsystem 110 can track a size and position of the floating window and can modify the contents of the floating window based on its size. Floating window management subsystem 110 can hide the floating window when the focus of browser application 104 returns to the tab with the virtual meeting client application.

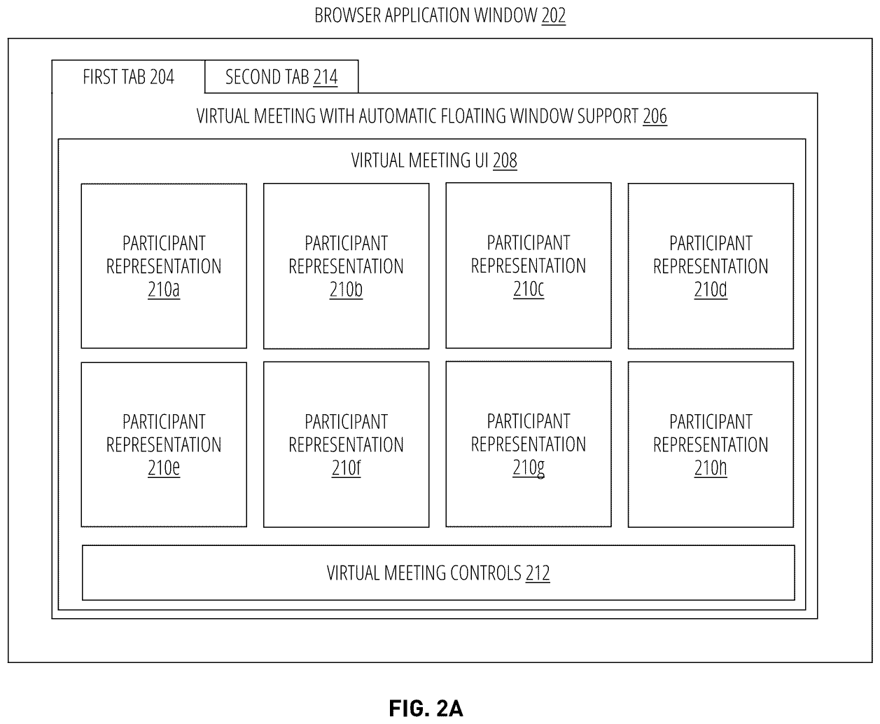

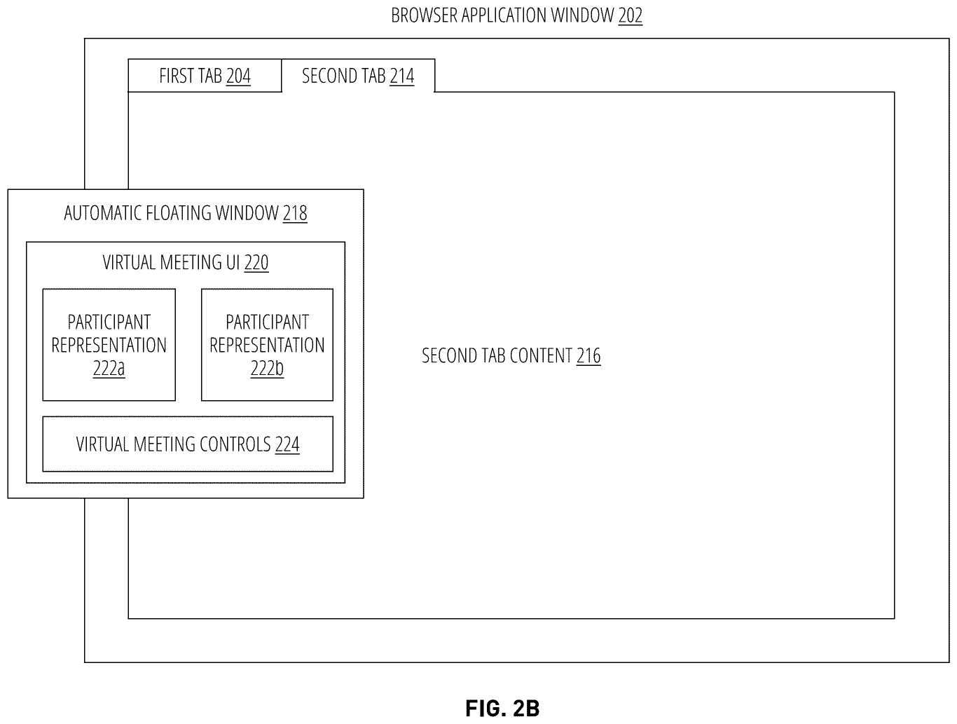

As an example, using browser application 104 of client device 102, a user can navigate to a virtual meeting application provided by virtual meeting server 114 (e.g., virtual meeting with automatic floating window support 106) and initiate or join a virtual meeting. Browser application 104 can render a user interface (UI) corresponding to the virtual meeting within a first tab (or window) (see FIG. 2A). Based on one or more user interactions, a focus of browser application 104 can be switched to a second tab (or window), and one or more elements associated with the virtual meeting (e.g., one or more visual and/or textual elements of the virtual meeting UI) can automatically be displayed in a floating window (see FIG. 2B).

In some embodiments, a user can navigate to an application that supports embedded virtual meetings to initiate or join a virtual meeting. For example, a document drafting application may include a virtual meeting client application in a sidebar of the document drafting application. While drafting a document, the user can join or initiate a virtual meeting via the embedded virtual meeting client application. Then, if a user switches focus of the browser application from the tab (or window) with the document drafting application and embedded virtual meeting client application to another tab (or window), one or more elements associated with the virtual meeting from the document drafting application can automatically be displayed in a floating window.

In some embodiments, the floating window can include any web elements. For example, the floating window can include arbitrary HyperText Markup Language (HTML) code. In some embodiments, the floating window includes an iframe HTML element that displays the virtual meeting client application.

In implementations of the disclosure, a “user” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether virtual meeting server 114 collects user information (e.g., information about a user's social network, social actions or activities, profession, a user's preferences, or a user's current location), or to control whether and/or how to receive content from virtual meeting server 114 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by virtual meeting server 114.

FIG. 2A depicts a view of a browser application window 202 including a virtual meeting with automatic floating window support 206, in accordance with one embodiment. A browser application can include virtual meeting with automatic floating window support 206 in first tab 204 of browser application window 202. The browser application can render virtual meeting UI 208 within virtual meeting with automatic floating window support 206. Virtual meeting UI 208 can include one or more virtual meeting participant representations (e.g., participant representation 210a-h) and virtual meeting controls 212. Participant representations 210a-h can include representations of virtual meeting participants. For example, participant representation 210a can include a visual representation (e.g., a picture, a live video, a video clip, etc.) or a textual representation (e.g., name, initials, title, etc.) of a first virtual meeting participant. In some embodiments, one of participant representations 210a-h can depict the user of browser application window 202. In some embodiments, one or more of participant representations 210a-h can depict another virtual meeting participant.

Virtual meeting controls 212 can include one or more elements to allow a user to interact with the virtual meeting. For example, virtual meeting controls 212 can include a mute button, a camera on/off button, a share screen button, a stop screen share button, a start floating window button, a stop virtual meeting button, a virtual reaction button (e.g., to virtually raise a hand, applaud, laugh, etc.), and/or the like. In some embodiments, a user can cause a floating window with virtual meeting elements to appear by interacting with the start floating window button. In some embodiments, the floating window with virtual meeting elements appears automatically when a focus of browser application window 202 is switched from first tab 204 to second tab 214.

In some embodiments, the floating window with virtual meeting elements appears automatically when a user shares at least a portion of their screen during the virtual meeting. For example, after interacting with the share screen button, a user may be prompted to select a portion of their screen (e.g., a tab of the browser application, an application, a window, a desktop, a region, etc.) to share in the meeting. In some embodiments, the user may share a tab of the browser application in the virtual meeting, causing other virtual meeting participants to see a visual representation of the tab of the browser application. When the user starts sharing a portion of their screen, the floating window with virtual meeting elements can automatically appear to allow the user to continue to participate in the virtual meeting while they share a portion of their screen.

Browser application window 202 can include one or more additional tabs of content, such as second tab 214. Second tab 214 can include content of another application, a website, a browser application configuration page, etc. In some embodiments, when a focus of the browser application is on first tab 204, the contents of second tab 214 can be hidden.

In some embodiments, virtual meeting with automatic floating window support 206 is included in a first window of the browser application and the contents of second tab 214 are included in a second window of the browser application instead of in a second tab.

FIG. 2B depicts a view of a browser application window 202 with an automatic floating window 218 containing virtual meeting elements within a virtual meeting UI 220, in accordance with one embodiment. Browser application window 202 may transition from the view depicted in FIG. 2A to the view depicted in FIG. 2B after a user interaction causes a focus of the browser application to switch from first tab 204 to second tab 214. When the focus switches from first tab 204 to second tab 214, automatic floating window 218 can automatically be displayed (e.g., via floating window management subsystem 110 of FIG. 1). In some embodiments, automatic floating window 218 can be known as a picture-in-picture (PIP) window.

As discussed above, second tab content 216 can include content of another application, a website, a browser application configuration page, and/or the like. One or more elements of virtual meeting with automatic floating window support 206 and/or virtual meeting UI 208 can be displayed within automatic floating window 218, and automatic floating window 218 can be displayed along with (e.g., alongside of, on top of, beneath, next to, etc.) second tab content 216.

In some embodiments, virtual meeting UI 220 can include a subset of elements from virtual meeting UI 208. For example, based on an initial size of automatic floating window 218, virtual meeting UI 220 may include two virtual meeting participant representations (e.g., participant representation 222a, participant representation 222b), which may correspond to two of the virtual meeting participant representations 210a-h of FIG. 2A. If a user interaction causes automatic floating window 218 to increase in size, one or more additional virtual meeting elements can be added to virtual meeting UI 220. For example, one or more additional virtual meeting participant representations can be displayed in virtual meeting UI 220 if the enlarged automatic floating window 218 has adequate space.

If a user interaction causes automatic floating window 218 to decrease in size, one or more virtual meeting elements of virtual meeting UI 220 can be hidden. For example, participant representation 222b can be hidden if there is not sufficient space in the shrunken automatic floating window 218. In some embodiments, automatic floating window 218 has a predetermined minimum allowable size and/or a predetermined maximum allowable size.

In some embodiments, virtual meeting controls 224 include a subset of virtual meeting controls 212. For example, virtual meeting controls 224 may initially include a mute button, a camera on/off button, a virtual reaction button, and a return to full virtual meeting button. In some embodiments, responsive to a user interaction with the virtual reaction button, a meeting interaction can occur. The meeting interaction can include submitting a vote to a poll associated with the virtual meeting, causing one or more virtual reactions (e.g., applaud, “thumbs-up”, laughing, etc.) to be displayed within the virtual meeting, and/or the like.

As the size of automatic floating window 218 changes in response to user interactions, one or more virtual meeting control elements can be added or removed from virtual meeting controls 224, as space permits.

In some embodiments, automatic floating window 218 can include one or more additional elements that are not related to the virtual meeting.

In some embodiments, automatic floating window 218 can include a sub-window that can appear with virtual meeting UI 220. In some embodiments, the sub-window can cover a portion or all of virtual meeting UI 220. The sub-window can include a pop-up notification or display a message to the user. In some embodiments, the sub-window can include one or more buttons to receive a user interaction with the sub-window. For example, in some cases, a sub-window can be displayed in automatic floating window 218 notifying the user that a virtual meeting event is occurring and asking if the user wants to switch back to the full virtual meeting UI. In some embodiments, the virtual meeting event can include a virtual meeting participant sharing content within the virtual meeting, the virtual meeting participants being divided into groups and starting separate virtual meetings, and/or the like.

Responsive to the user confirming their intent to switch back to the full virtual meeting UI (e.g., via an interaction with a button of the sub-window), a focus of the browser application can switch back to first tab 204, the automatic floating window 218 can be hidden (e.g., can disappear), and virtual meeting elements of first tab 204 (e.g., virtual meeting UI 208) can be displayed again.

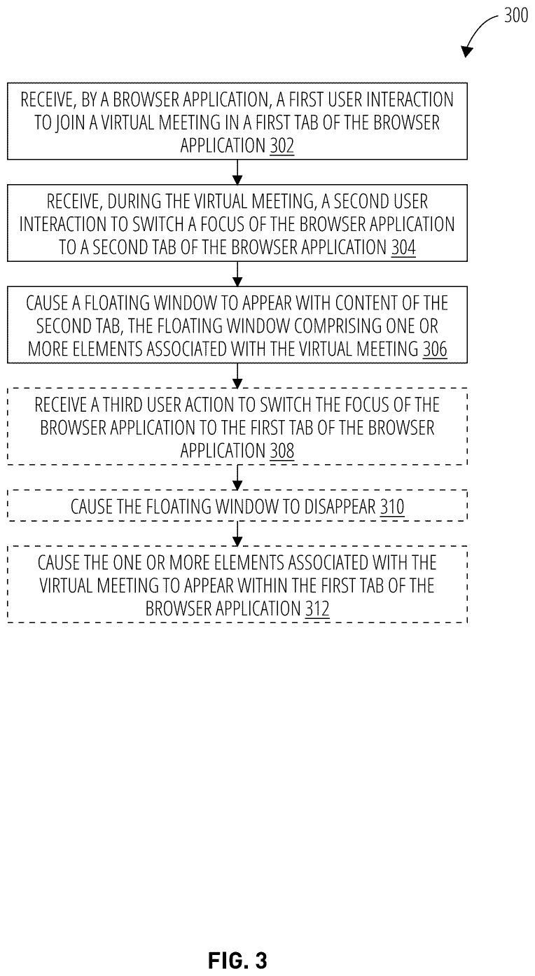

FIG. 3 depicts a flow diagram of an example method for automatically displaying virtual meeting elements in a floating window of a browser application, in accordance with at least one embodiment. Method 300 can be performed by processing logic that can include hardware (circuitry, dedicated logic, etc.), software (e.g., instructions run on a processing device), or a combination thereof. In at least one implementation, some or all of the operations of method 300 can be performed by one or more components of system 100 for automatically displaying virtual meeting elements in a floating window of a browser application of FIG. 1. For example, in some embodiments, method 300 can be performed by browser application 104 of FIG. 1.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states e.g., via a state diagram. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

Referring to FIG. 3, at block 302, processing logic can receive, by a browser application, a first user interaction to join a virtual meeting in a first tab of the browser application. In some embodiments, the first user interaction to join a virtual meeting occurs within a web application that supports embedded virtual meetings. For example, the user may navigate the browser application to a document drafting application and may join a virtual meeting that is embedded in a sidebar of the document drafting application.

At block 304, processing logic can receive, during the virtual meeting, a second user interaction to switch a focus of the browser application to a second tab of the browser application. At block 306, responsive to the focus of the browser application switching to the second tab of the browser application, processing logic can cause a floating window to appear with (e.g., alongside of, on top of, next to, etc.) content of the second tab. The floating window can include one or more elements associated with the virtual meeting.

In some embodiments, at block 308, processing logic can receive a third user interaction to switch the focus of the browser application to the first tab of the browser application. At block 310, responsive to the focus of the browser application switching to the first tab of the browser application, processing logic can cause the floating window to disappear. At block 312, in further response to the focus of the browser application switching to the first tab of the browser application, processing logic can cause the one or more elements associated with the virtual meeting to appear within the first tab of the browser application.

In some embodiments, processing logic can receive a user interaction (e.g., a third user interaction) to enlarge the floating window. Processing logic can, responsive to the enlarging of the floating window, cause additional elements associated with the virtual meeting to appear within the floating window. For example, one or more additional virtual meeting participant representations can be included in the enlarged floating window.

In some embodiments, processing logic can receive a user interaction (e.g., a third user interaction) to shrink the floating window. Processing logic can, responsive to the shrinking of the floating window, cause a subset of the one or more elements associated with the virtual meeting to disappear from the floating window. For example, one or more virtual meeting participant representations can be hidden and/or removed from the shrunken floating window.

In some embodiments, processing logic can cause a sub-window to be displayed within the floating window. Processing logic can receive a user interaction with the sub-window in the floating window. Processing logic can, responsive to the user interaction with the sub-window in the floating window, cause the focus of the browser application to switch to the first tab. The floating window can disappear and/or be hidden, and the elements associated with the virtual meeting can appear within the first tab of the browser application.

FIG. 4 is a block diagram illustrating an exemplary computer system, in accordance with at least one embodiment of the present disclosure. The computer system 400 can correspond to client device 102, described with respect to FIG. 1. Computer system 400 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processing device (processor) 402, a main memory 404 (e.g., read-only memory (ROM), flash memory, dynamic random access memory (DRAM) such as synchronous DRAM (SDRAM), double data rate (DDR SDRAM), or DRAM (RDRAM), etc.), a static memory 406 (e.g., flash memory, static random access memory (SRAM), etc.), and a data storage device 416, which communicate with each other via a bus 428.

Processor (processing device) 402 represents one or more general-purpose processing devices such as a microprocessor, central processing unit, or the like, and may include processing logic 422. More particularly, the processor 402 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 can also be one or more special-purpose processing devices such as an application specific integrated circuit (ASIC), a field programmable gate array (FPGA), a digital signal processor (DSP), network processor, or the like. The processor 402 is configured to execute instructions 426 (e.g., for generating threat indicator alerts) for performing the operations discussed herein.

The computer system 400 can further include a network interface device 408. The computer system 400 also can include a video display unit 410 (e.g., a liquid crystal display (LCD) or a cathode ray tube (CRT)), an input device 412 (e.g., a keyboard, and alphanumeric keyboard, a motion sensing input device, touch screen), a cursor control device 414 (e.g., a mouse), and a signal generation device 418 (e.g., a speaker). In some embodiments, computer system 400 may not include video display unit 410, input device 412, and/or cursor control device 414 (e.g., in a headless configuration).

The data storage device 416 can include a non-transitory machine-readable storage medium 424 (also computer-readable storage medium) on which is stored one or more sets of instructions 426 (e.g., for automatically displaying virtual meeting elements in a floating window of a browser application) embodying any one or more of the methodologies or functions described herein. The instructions 426 can also reside, completely or at least partially, within the main memory 404 and/or within the processor 402 during execution thereof by the computer system 400, the main memory 404 and the processor 402 also constituting machine-readable storage media. The instructions can further be transmitted or received over a network 420 via the network interface device 408.

In one implementation, the instructions 426 include instructions for automatically displaying virtual meeting elements in a floating window of a browser application. While the computer-readable storage medium 424 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
receiving, by a browser application, a first user interaction to join a virtual meeting in a first tab of the browser application;
receiving, during the virtual meeting, a second user interaction to switch a focus of the browser application to a second tab of the browser application; and
responsive to the focus of the browser application switching to the second tab of the browser application, causing a floating window to appear along with content of the second tab, the floating window comprising one or more elements associated with the virtual meeting.

2. The method of claim 1, further comprising:
receiving a third user interaction to switch the focus of the browser application to the first tab of the browser application; and
responsive to the focus of the browser application switching to the first tab of the browser application:
causing the floating window to disappear; and
causing the one or more elements associated with the virtual meeting to appear within the first tab of the browser application.

3. The method of claim 1, further comprising:
receiving a third user interaction to enlarge the floating window; and
responsive to the enlarging of the floating window, causing additional elements associated with the virtual meeting to appear within the floating window.

4. The method of claim 1, further comprising:
receiving a third user interaction to shrink the floating window; and
responsive to the shrinking of the floating window, causing a subset of the one or more elements associated with the virtual meeting to disappear from the floating window.

5. The method of claim 1, further comprising:
causing a sub-window to be displayed in the floating window;
receiving a third user interaction with the sub-window in the floating window; and
responsive to the third user interaction with the sub-window in the floating window, causing the focus of the browser application to switch to the first tab.

6. The method of claim 1, further comprising:
receiving a third user interaction with a first element of the one or more elements associated with the virtual meeting; and
responsive to receiving the third user interaction with the first element of the one or more elements associated with the virtual meeting, causing a meeting interaction to occur with the virtual meeting.

7. The method of claim 1, wherein the first tab of the browser application comprises a web application that supports embedded virtual meetings.

8. A system comprising:
a memory device; and
a processing device coupled to the memory device, the processing device to perform operations comprising:
receiving, by a browser application, a first user interaction to join a virtual meeting in a first tab of the browser application;
receiving, during the virtual meeting, a second user interaction to switch a focus of the browser application to a second tab of the browser application; and
responsive to the focus of the browser application switching to the second tab of the browser application, causing a floating window to appear along with content of the second tab, the floating window comprising one or more elements associated with the virtual meeting.

9. The system of claim 8, the operations further comprising:
receiving a third user interaction to switch the focus of the browser application to the first tab of the browser application; and
responsive to the focus of the browser application switching to the first tab of the browser application:
causing the floating window to disappear; and
causing the one or more elements associated with the virtual meeting to appear within the first tab of the browser application.

10. The system of claim 8, the operations further comprising:
receiving a third user interaction to enlarge the floating window; and
responsive to the enlarging of the floating window, causing additional elements associated with the virtual meeting to appear within the floating window.

11. The system of claim 8, the operations further comprising:
receiving a third user interaction to shrink the floating window; and
responsive to the shrinking of the floating window, causing a subset of the one or more elements associated with the virtual meeting to disappear from the floating window.

12. The system of claim 8, the operations further comprising:
causing a sub-window to be displayed in the floating window;
receiving a third user interaction with the sub-window in the floating window; and
responsive to the third user interaction with the sub-window in the floating window, causing the focus of the browser application to switch to the first tab.

13. The system of claim 8, the operations further comprising:
receiving a third user interaction with a first element of the one or more elements associated with the virtual meeting; and
responsive to receiving the third user interaction with the first element of the one or more elements associated with the virtual meeting, causing a meeting interaction to occur with the virtual meeting.

14. The system of claim 8, wherein the first tab of the browser application comprises a web application that supports embedded virtual meetings.

15. A non-transitory computer-readable storage medium comprising instructions that, when executed by a processing device, cause the processing device to perform operations comprising:
receiving, by a browser application, a first user interaction to join a virtual meeting in a first tab of the browser application;
receiving, during the virtual meeting, a second user interaction to switch a focus of the browser application to a second tab of the browser application; and
responsive to the focus of the browser application switching to the second tab of the browser application, causing a floating window to appear along with content of the second tab, the floating window comprising one or more elements associated with the virtual meeting.

16. The non-transitory computer-readable storage medium of claim 15, the operations further comprising:
receiving a third user interaction to switch the focus of the browser application to the first tab of the browser application; and
responsive to the focus of the browser application switching to the first tab of the browser application:
causing the floating window to disappear; and
causing the one or more elements associated with the virtual meeting to appear within the first tab of the browser application.

17. The non-transitory computer-readable storage medium of claim 15, the operations further comprising:
receiving a third user interaction to enlarge the floating window; and
responsive to the enlarging of the floating window, causing additional elements associated with the virtual meeting to appear within the floating window.

18. The non-transitory computer-readable storage medium of claim 15, the operations further comprising:
receiving a third user interaction to shrink the floating window; and
responsive to the shrinking of the floating window, causing a subset of the one or more elements associated with the virtual meeting to disappear from the floating window.

19. The non-transitory computer-readable storage medium of claim 15, the operations further comprising:
causing a sub-window to be displayed in the floating window;
receiving a third user interaction with the sub-window in the floating window; and
responsive to the third user interaction with the sub-window in the floating window, causing the focus of the browser application to switch to the first tab.

20. The non-transitory computer-readable storage medium of claim 15, the operations further comprising:
receiving a third user interaction with a first element of the one or more elements associated with the virtual meeting; and
responsive to receiving the third user interaction with the first element of the one or more elements associated with the virtual meeting, causing a meeting interaction to occur with the virtual meeting.
